(19) United States
(12) Patent Application Publication
(10) Pub. No.: US 2019/0080011 A1
(43) Pub. Date: Mar. 14, 2019

(54) INFORMATION DISPLAY DEVICE, INFORMATION DISPLAY METHOD, PROGRAM AND INFORMATION DISPLAY SYSTEM

(71) Applicant: PIONEER CORPORATION, Bunkyo-ku, Tokyo (JP)

(72) Inventor: Tetsuya MITSUI, Kawasaki (JP)

(73) Assignee: Pioneer Corporation, Bunkyo-ku, Tokyo (JP)

(21) Appl. No.: 16/081,868

(22) PCT Filed: Mar. 1, 2016
(86) PCT No.: PCT/JP2016/056213

§ 371 Date: Aug. 31, 2018

(51) Int. Cl. G06F 17/30

(52) U.S. Cl. CPC G06F 17/30867; G06F 17/30991; G06F 17/30997; G06F 17/30525

(57) ABSTRACT

The information display system receives a search condition for searching for facilities from a user, and obtains an attribute and/or a current situation of the user. Next, the information display system searches for facilities based on the search condition, an attribute and/or a current situation of the user, and outputs facility information relevant to the facilities. Then, the information display system obtains additional information for the facilities, and displays the additional image indicating the additional information, together with the facility information.

### TECHNICAL FIELD

The present invention relates to a technique of displaying information relevant to facilities.

### BACKGROUND TECHNIQUE

There is known a technique of presuming and recommending information that a user wants when the user makes a search using search keywords in an onboard device such as a car navigation device. For example, in a system disclosed in Patent Reference-1, the service candidate providing server presumes service candidates based on user's character such as an attribute, a taste and a history of the user, and transmits its result to the onboard device. The onboard device selects the service candidates in consideration of the user's situation and displays the result of the selection.

### PRIOR ART REFERENCES

### Patent References

Patent Reference-1: Japanese Patent Application Laid-Open under No. 2005-208943

### SUMMARY OF THE INVENTION

### Problem to be Solved by the Invention

In the technique of Patent Reference-1, the search results are selected based on the user's situation. Therefore, when the search results based on the situation are not needed, it is not possible to provide the search result that the user wants. Also, when the search is made without consideration of the user's situation, the user actually needs to access the details of the respective search results in the list of the search results so as to know whether or not the search results include information that the user explicitly or implicitly wants.

The above is an example of the problem to be solved by the present invention. It is an object of the present invention to provide an information display technique by which a user can obtain information that he wants only by seeing the displayed search results.

### Means for Solving the Problem

An invention described in claims is an information display device comprising: a receiving unit configured to receive a search condition from a user; a search object obtaining unit configured to obtain search object information indicating a search object searched based on the search condition; an additional information obtaining unit configured to obtain additional information with respect to the search object, based on the search condition, an attribute and/or a current situation of the user; and a display unit configured to display an additional image indicating the additional information, together with the search object information.

Another invention described in claims is an information display method executed by an information display device, comprising: a receiving process configured to receive a search condition from a user; a search condition obtaining process configured to obtain search object information indicating a search object searched based on the search condition; an additional information obtaining process configured to obtain additional information with respect to the search object, based on the search condition, an attribute and/or a current situation of the user; and a display process configured to display an additional image indicating the additional information, together with the search object information.

Still another invention described in claims is a program executed by an information display device including a computer, the program causing the computer to function as: a receiving unit configured to receive a search condition from a user; a search object obtaining unit configured to obtain search object information indicating a search object searched based on the search condition; an additional information obtaining unit configured to obtain additional information with respect to the search object, based on the search condition, an attribute and/or a current situation of the user; and a display unit configured to display an additional image indicating the additional information, together with the search object information.

Still another invention described in claims is an information display system comprising: a receiving unit configured to receive a search condition from a user; a first obtaining unit configured to obtain an attribute and/or a current situation of the user; a second obtaining unit configured to obtain search object information indicating a search object searched based on the search condition; a third obtaining unit configured to obtain additional information with respect to the search object, based on the search condition, an attribute and/or a current situation of the user; and a display unit configured to display an additional image indicating the additional information, together with the search object information.

### BRIEF DESCRIPTION OF THE DRAWINGS

FIG. 1 illustrates a whole configuration of an information display system according to an embodiment of the present invention.

FIG. 2 illustrates an example of context.

FIGS. 3A and 3B illustrate display examples of search results.

FIG. 4 is a flowchart of search processing.

FIG. 5 illustrates an example of configuration of a tag recommending unit.

FIG. 6 is a flowchart of learning processing of a classifier.

FIGS. 7A and 7B illustrate display examples of search results according to a modified example.

### DETAILED DESCRIPTION OF THE PREFERRED EMBODIMENTS

According to one aspect of the present invention, there is provided an information display device comprising: a receiving unit configured to receive a search condition from a user; a search object obtaining unit configured to obtain search object information indicating a search object searched based on the search condition; an additional information obtaining unit configured to obtain additional information with respect to the search object, based on the search condition, an attribute and/or a current situation of the user; and a display unit configured to display an additional image indicating the additional information, together with the search object information.

The above information display device receives a search condition for searching for facilities from a user, and obtains search object information indicating a search object searched based on the search condition. Also, the information display device obtains additional information with respect to the search object, based on the search condition, an attribute and/or a current situation of the user. Then, the information display device displays an additional image indicating the additional information, together with the search object information. Thus, it becomes possible to determine appropriate additional information based on the attribute and/or the current situation of the user and display the additional image indicating the additional information.

In one mode of the above information display device, the search object information includes facility information relevant to a facility, and the display unit preferentially displays the facility information of a facility having the additional information, out of a plurality of facility information, in accordance with a designation by the user. In this mode, the additional information can be positively presented to the user.

In another mode of the above information display device, the search object information includes facility information relevant to a facility, the additional information is information relevant to equipment existing in the facility, and the display unit displays detailed image information indicating a position of the equipment in the facility when the user selects the additional information. In this mode, when the user is interested in the additional information, it becomes possible to present more detailed information.

In still another mode of the above information display, the search object obtaining unit obtains the facility information obtained by a new search based on the search condition including the equipment corresponding to the additional image when the user selects the additional information, and the display unit displays the facility information obtained by the new search. In this mode, when the user is interested in the additional information, it becomes possible to present search results of the search using the additional information as the search condition.

In still another mode of the above information display device, the additional information obtaining unit obtains the additional information based on the attribute and/or the current situation of the user obtained, without receiving an input by the user.

According to another aspect of the present invention, there is provided an information display method executed by an information display device, comprising: a receiving process configured to receive a search condition from a user; a search condition obtaining process configured to obtain search object information indicating a search object searched based on the search condition; an additional information obtaining process configured to obtain additional information with respect to the search object, based on the search condition, an attribute and/or a current situation of the user; and a display process configured to display an additional image indicating the additional information, together with the search object information. By this method, it becomes possible to determine appropriate additional information based on the attribute and/or the current situation of the user and display the additional image indicating the additional information.

According to another aspect of the present invention, there is provided a program executed by an information display device including a computer, the program causing the computer to function as: a receiving unit configured to receive a search condition from a user; a search object obtaining unit configured to obtain search object information indicating a search object searched based on the search condition; an additional information obtaining unit configured to obtain additional information with respect to the search object, based on the search condition, an attribute and/or a current situation of the user; and a display unit configured to display an additional image indicating the additional information, together with the search object information. By executing this program, it becomes possible to determine appropriate additional information based on the attribute and/or the current situation of the user and display the additional image indicating the additional information. This program may be handled in a manner stored in a storage medium.

According to still another aspect of the present invention, there is provided an information display system comprising: a receiving unit configured to receive a search condition from a user; a first obtaining unit configured to obtain an attribute and/or a current situation of the user; a second obtaining unit configured to obtain search object information indicating a search object searched based on the search condition; a third obtaining unit configured to obtain additional information with respect to the search object, based on the search condition, an attribute and/or a current situation of the user; and a display unit configured to display an additional image indicating the additional information, together with the search object information.

The above information display system receives a search condition for searching for facilities from a user, and obtains an attribute and/or a current situation of the user. Next, the information display system obtains search object information indicating a search object searched based on the search condition. Also, the information display system obtains additional information with respect to the search object, based on the search condition, an attribute and/or a current situation of the user. Then, the information display system displays an additional image indicating the additional information, together with the search object information. Thus, it becomes possible to determine appropriate additional information based on the attribute and/or the current situation of the user and display the additional image indicating the additional information.

### EMBODIMENTS

Preferred embodiments of the present invention will be described below with reference to the accompanied drawings.

[Whole Configuration]

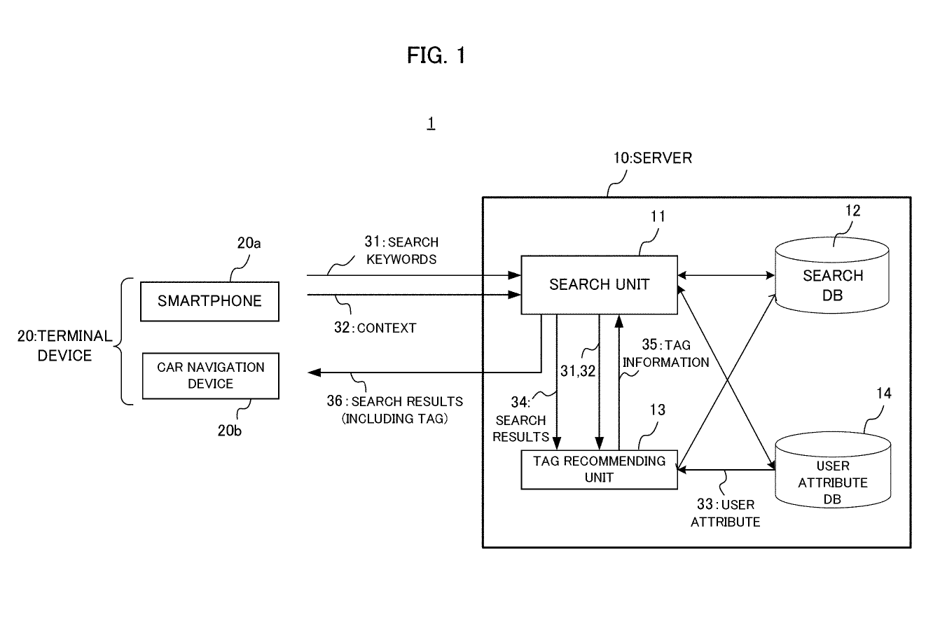

FIG. 1 illustrates a whole configuration of an information display system 1 according to an embodiment of the present invention. The information display system. 1 includes a server 10 and a terminal device 20. The terminal device 20 may be a smartphone 20a or a car navigation device 20b loaded on a vehicle, for example. The terminal device 20 communicates with the server 10 by wireless communication. The server 10 includes a search unit 11, a search database (“database” will be simply expressed as “DB”) 12, a tag recommending unit 13 and a user attribute DB 14.

First, an outline of the operation of the information display system 1 will be described. The information display system 1 is characteristic in displaying additional information relevant to facilities (hereinafter referred to as “tag information”) together with the search result, when a user searches for the facilities. Basically, the tag information is information relevant to equipment existing in the facility. Specifically, when a user inputs search keywords and instructs the search, the server 10 searches for the facilities based on the inputted search keywords and obtains one or more search results. Additionally, based on the search keywords, the obtained search results, context and the user attribute, the server 10 determines the tag information to be recommended to the user in association with the facility obtained as the search result, and presents the tag information to the user together with the search results. It is noted that “context” is information indicating current situation of the user.

As concrete examples, in a first example, when the user makes a search by inputting search keywords “shopping mall”, the server 10 obtains the facility information of plural shopping malls as the search results. In addition, the server 10 determines that the user has a baby based on the context and/or the user attribute, and adds the tag information indicating a nursing room to the shopping malls having the nursing room, when it presents the list of the plural shopping malls obtained as the search results.

In a second example, when the user makes a search by inputting search keywords “convenience store”, the server 10 obtains the facility information of plural convenience stores as the search results. In addition, the server 10 determines that the user is continuously driving the vehicle more than two hours and a female passenger is on the vehicle based on the context, and adds the tag information indicating a toilet to the convenience stores having the toilet, when it presents the list of the plural convenience stores obtained as the search results.

In a third example, when the user makes a search by inputting search keywords “facility with a parking lot”, the server 10 obtains the facility information of plural facilities with a parking lot as the search results. In addition, the server 10 determines that it will rain with high possibility at the time when the user will reach the destination based on the context, and adds the tag information indicating a roofed parking lot to the facilities having the roofed parking lot, when it presents the list of the plural facilities with a parking lot obtained as the search results.

Next, specific processing by the information display system 1 will be described with reference to FIG. 1. When the user inputs the search keywords and instructs the search to the terminal device 20, the search keywords 31 and the context 32 are transmitted from the terminal device 20 to the server 10.

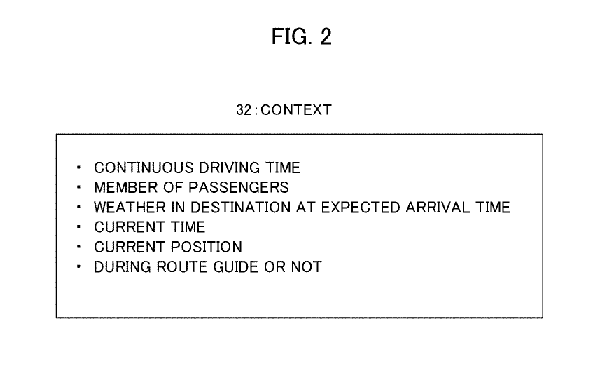

FIG. 2 illustrates an example of the context 32. The context is obtained by the terminal device 20 and is stored in the terminal device 20. In the example of FIG. 2, the context 32 includes “Continuous driving time”, “Member of passengers”, “Weather in destination at expected arrival time”, “Current time”, “Current position”, “During route guidance or not”. “Continuous driving time” is obtained by a control unit of the vehicle or the navigation device 20b, and “Member of passengers” is inputted by the user or obtained by a sensor or a camera installed in the vehicle. “Weather in destination at expected arrival time” is obtained by the terminal device 20 from an external server via the Internet. “Current time” may be obtained from an internal clock of the terminal device 20, and “Current position” may be obtained by the GPS installed in the terminal device 20. Information of “During route guide or not” may be obtained from the navigation application operating in the terminal device 20.

Returning to FIG. 1, the search unit 11 makes a search using the search keywords 31 obtained from the terminal device 20 by referring to the search DB 12, and obtains one or plural facility information as the search results 34. Then, the search unit 11 sends the search result 34 thus obtained, the search keywords 31 and the context 32 to the tag recommending unit 13. The tag recommending unit 13 obtains the user attribute 33 from the user attribute DB 14, in addition to the search keywords 31, the context 32 and the search result 34, determines the tag information 35 to be recommended to the user based on those information, and sends the tag information 35 to the search unit 11. As described later, the tag information 35 includes tag contents 35x. Then, the search unit 11 transmits the search results 36 including the tag information 35 to the terminal device 20 based on the search results 34 and the tag information 35.

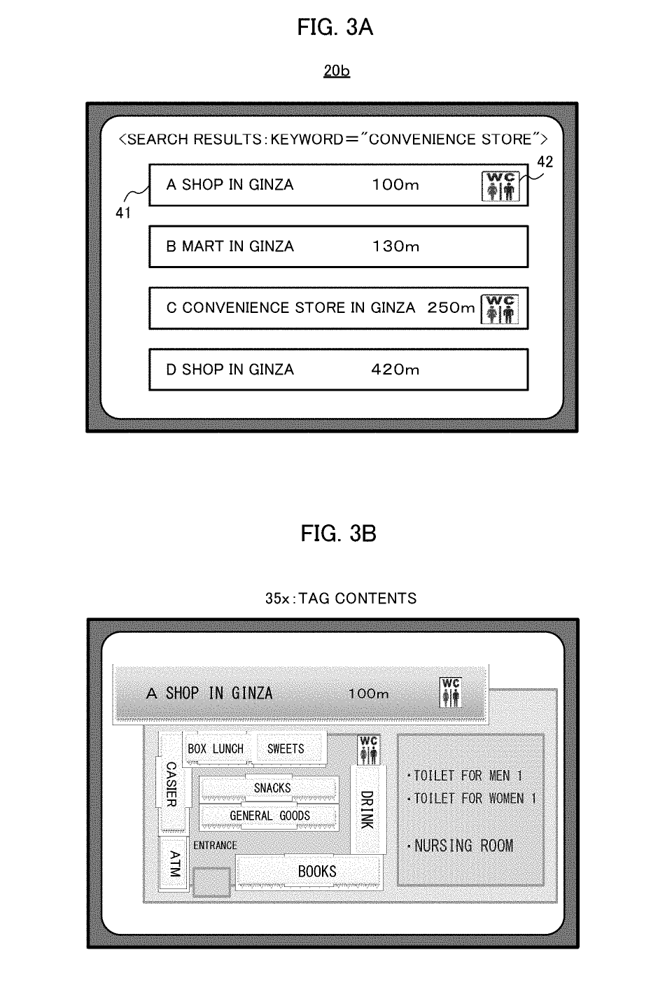

The terminal device 20 receives the search results 36 including the tag information 35 and displays them on a display unit. FIG. 3A is a display example of the search results. FIG. 3A is the display example in the above-described second example. The user inputs the search keywords “convenience store” and makes a search, and the search result bars 41 indicating four convenience stores are displayed as the search results. Also, since “Toilet” is determined as the tag information to be recommended to the user, the tag icons 42 indicating the toilet are displayed in the search result bars 41 of the convenience store having the toilet, among the four convenience stores.

As described above, in this embodiment, the search results are displayed based on the search keywords inputted by the user, and if there is tag information 35 to be recommended to the user in consideration of the context at that time and/or the user attribute, the tag icon 42 indicating the tag information 35 is displayed. Therefore, the basic search results are displayed first, and the tag information may be naturally presented to the user.

In the display exampled shown in FIG. 3A, if the user touches the tag icon 42, the tag contents 35x shown in FIG. 3B are displayed. The tag contents 35x is information indicating the detail of the tag information 35 that the tag icon 42 indicates. In the example of FIG. 3B, the store map including the toilet is displayed as the tag contents 35x corresponding to the tag icon 42 of toilet. By displaying the tag contents 35x when the user selects the tag information 35 in this way, more detailed information may be presented to the user if the user is interested in the tag information 35.

In the above description, the search results 34 are examples of the facility information of the present invention, the context 32 is an example of the current situation of the present invention, the tag information 35 is an example of the additional information of the present invention, and the tag icon 42 is an example of the additional image in the present invention.

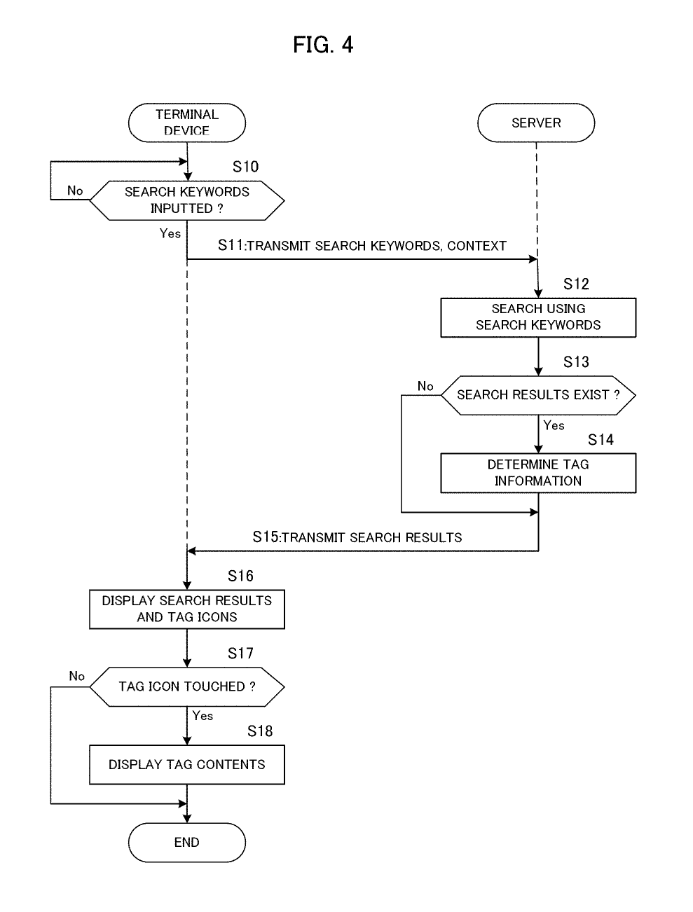

Next, search processing by the information display system 1 will be described. FIG. 4 is a flowchart of the search processing. This processing is executed by the server 10 and the terminal device 20.

First, the terminal device 20 determines whether or not the user inputs the search keywords 31 (step S10). When the search keywords 31 are inputted (step S10: Yes), the terminal device 20 transmits the search keywords 31 and the context 32 at that time to the server 10 (step S11).

The server 10 receives the search keywords 31 and the context 32, and searches for the facilities based on the search keywords 31 (step S12). If there exist search results (step S13: Yes), the server 10 determines the tag information 35 to be recommended, based on the search keywords 31, the search results 34, the context 32 and/or the user attribute 33 (step S14). On the other hand, if there exists no search result (step S13: No), the server 10 does not determine the tag information 35. Then, the server 10 transmits the search results 36 to the terminal device 20 (step S15). At that time, if the tag information 35 is determined in step S14, the tag information 35 is included in the search results 36 and transmitted to the terminal device 20. If there exists no search result in step S13, a message indicating that there exists no search result is transmitted to the terminal device 20.

When receiving the search results 36, the terminal device 20 displays the search result bars 41 and the tag icons 42 corresponding to the tag information 35 as shown in the example of FIG. 3A (step S16). Next, the terminal device 20 determines whether or not the tag icon 42 is touched by the user (step S17). If the tag icon 42 is not touched (step S17: No), the processing ends. On the other hand, if the tag icon 42 is touched (step S17: Yes), the terminal device 20 displays the tag contents 35x corresponding to the tag icon 42 as shown in the example of FIG. 3B (step S18). Then, the processing ends.

[Tag Recommending Unit]

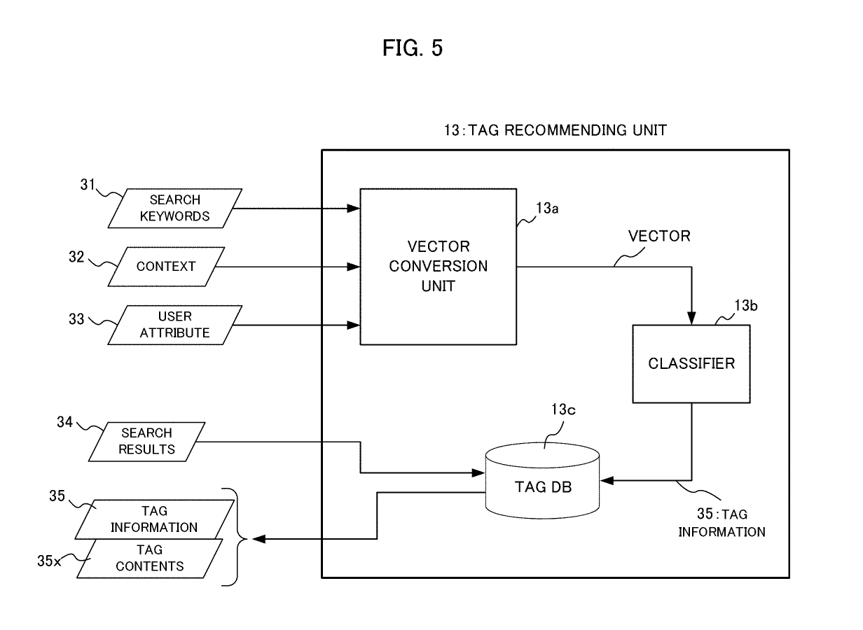

Next, the tag recommending unit 13 in the server 10 will be described in detail. As described above, the tag recommending unit 13 determines the tag information 35 based on the search keywords 31, the context 32, the user attribute 33 and the search results 34. FIG. 5 illustrates an example of a configuration of the tag recommending unit 13. The tag recommending unit 13 includes a vector conversion unit 13a, a classifier 13b and a tag DB 13c.

The vector conversion unit 13a generates a vector based on the inputted search keywords 31, the context 32 and the user attribute 33, and supplies it to the classifier 13b. This vector is matrix data indicating the combination of the search keywords 31, the context 32 and the user attribute 33. The classifier 13b determines plural candidates of the tag information 35 based on the inputted vector, and selects the most appropriate tag information 35 from those candidates and supplies it to the tag DB 13c. The tag DB 13c stores tag contents 35x corresponding to the facility, for each POI (Point Of Interest) of plural facilities. The tag recommending unit 13 reads out the tag contents 35x from the tag DB 13c based on the search results 34 and the tag information 35 determined by the classifier 13b, and outputs it with the tag information 35.

For example, in the above-described second example, the vector conversion unit 13a generates the vector based on the search keywords “convenience store”, the context and the user attribute, and supplies it to the classifier 13b. The classifier 13b determines the tag information “Toilet” which fits to the vector best, and supplies it to the tag DB 13c. Also, the POI indicating plural convenience stores are inputted to the tag DB 13c as the search results 34. The tag DB 13c outputs the tag contents 35x (the store map in this example) for one or plural convenience stores having the tag information “Toilet”.

Next, learning processing of the classifier 13b in the tag recommending unit 13 will be described. The classifier 13b performs learning according to whether or not the tag information 35 presented to the user is actually selected by the user. When the search results recommending “Toilet” as the tag information 35 are displayed as shown in FIG. 3A, if the user presses the search result bars 41 of “A-SHOP” or “C-CONVENIENCE STORE” or the tag icons 42, it is presumed that the user is interested in the tag information “Toilet”. Namely, perhaps the tag information “Toilet” recommended by the tag recommending unit 13 is what the user wanted, and recommending the tag information “Toilet” was right. Therefore, the classifier 13b performs weighting to the combination of the search keywords, the context and the user attribute at that time such that the tag information “Toilet” becomes more appropriate. Thus, if the same combination is inputted after that, “Toilet” is determined as the tag information with higher probability.

On the other hand, if the user does not press the search result bars 41 of “A-SHOP” or “C-CONVENIENCE STORE” or the tag icons 42, it is presumed that the user is not interested in the tag information “Toilet”. Namely, perhaps the recommended tag information “Toilet” is not what the user wanted, and recommending the tag information “Toilet” was wrong. Therefore, the classifier 13b performs weighting to the combination of the search keywords, the context and the user attribute at that time such that the tag information “Toilet” becomes less appropriate. Thus, if the same combination is inputted after that, “Toilet” is determined as the tag information with lower probability. In this way, by executing the learning of the classifier 13b based on the presence/absence of the user's selection of the presented tag information, it becomes possible to present more appropriate tag information to the user.

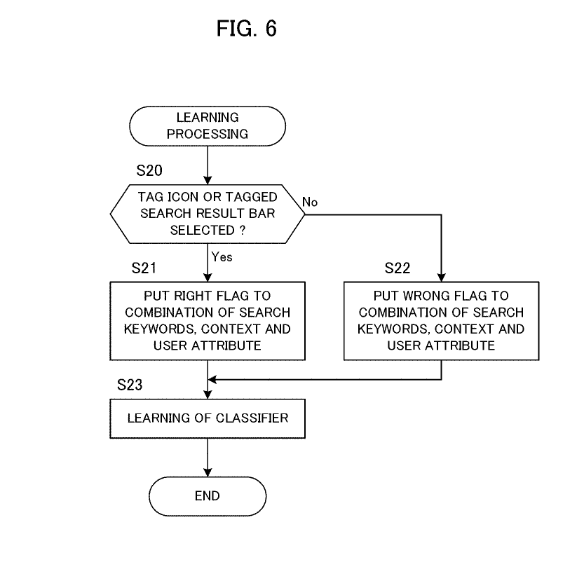

FIG. 6 is a flowchart of the learning processing of the classifier 13b. This processing is mainly executed by the tag recommending unit 13 in the server 10. First, the user's selection result, in response to the search results displayed in the terminal device 20 as shown in FIG. 3A, is transmitted from the terminal device 20 to the server 10. The tag recommending unit 13 determines whether or not the tag icon 42 or the search result bar 41 including the tag icon 42 (hereinafter referred to as “search result bar 41 with tag) is selected (step S20).

If the tag icon 42 or the search result bar 41 with tag is selected (step S20: Yes), the tag recommending unit 13 puts a right flag to the combination of the search keywords, the context and the user attribute at that time (step S21). On the other hand, if the tag icon 42 or the search result bar 41 with tag is not selected (step S20: No), the tag recommending unit 13 puts a wrong flag to the combination of the search keywords, the context and the user attribute at that time (step S22). Then, the tag recommending unit 13 performs the learning of the classifier 13b based on the result of updating the flag in steps S21 or S22 (step S23). Specifically, the tag recommending unit 13 makes the weight of the tag information larger to the combination to which the right flag is put, and makes the weight of the tag information smaller to the combination to which the wrong flag is put. Thus, the learning of the classifier 13b is performed based on the user's selection of the presented tag information.

### MODIFIED EXAMPLES

The following modified examples may be suitably applied in combination.

### Modified Example 1

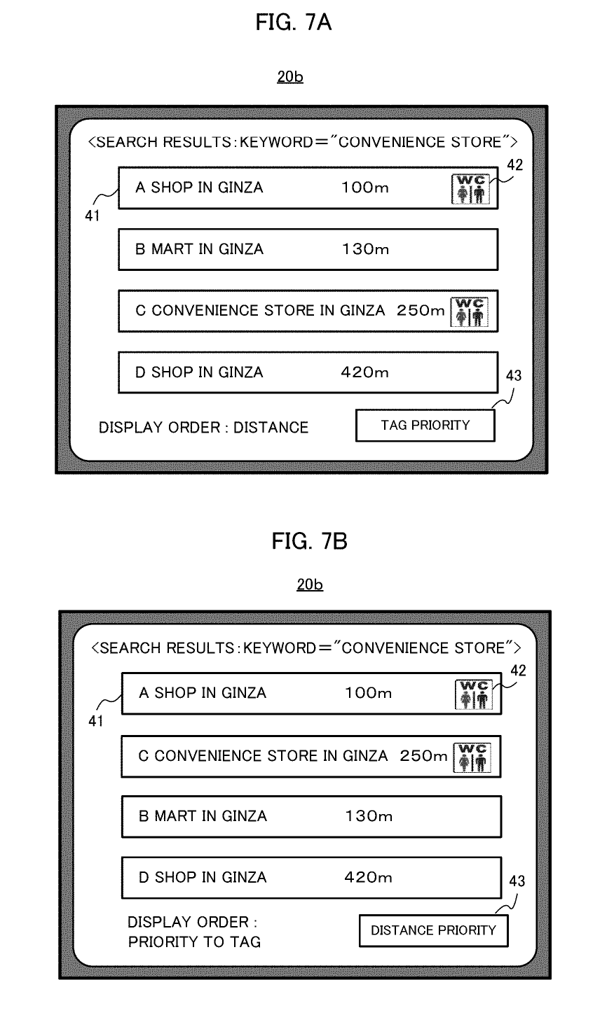

FIGS. 7A and 7B illustrate other examples of the search results including tag information. In the example of FIG. 3A, the search results are displayed in the order the distance from the current position, i.e., from the nearest one to the farthest one, regardless of the present/absence of the tag information. In contrast, in the example of FIG. 7A, the user can select one of the display mode in which the distance from the current position is preferential (hereinafter referred to as “distance priority mode”) and the display mode in which the tag information is preferential (hereinafter referred to as “tag priority mode”). Specifically, FIG. 7A is an example of the distance priority mode, wherein each search results are displayed in the order from the one nearest from the current position. If the user presses the switch button 43 labeled “TAG PRIORITY”, the display is switched to the tag priority mode shown in FIG. 7B. As shown in FIG. 7B, in the tag priority mode, the search results including the tag information are displayed with higher priority. In FIG. 7B, if the user presses the switch button 43 labeled “DISTANCE PRIORITY”, the display is switched to the distance priority mode shown in FIG. 7A. Thus, the user can select his or her favorite display mode.

### Modified Example 2

While determining the tag information and/or supplying the tag contents are performed on the server 10 side in the above embodiment, those processing may be performed on the terminal 20 side. Specifically, the terminal device 20 is provided with the search unit 11, the search DB 12, the tag recommending unit 13 and the user attribute DB 14, which are provided in the server 10 in the above embodiment, and the terminal device 20 may determine the tag information and present the tag information to the user. In another example, the server 10 may be provided with the search unit 11 and the search DB 12, and the terminal device 20 may be provided with the tag recommending unit 13 and the user attribute DB 14. In this case, the server 10 performs the search based on the search keywords and transmits the search results to the terminal device 20. The terminal device 20 determines the tag information by the tag recommending unit 13 based on the received search results, and presents the tag information to the user.

### Modified Example 3

In the above embodiment, when the user touches the tag icon 42 in the display example of the search results shown in FIG. 3A, the corresponding tag contents are displayed. Instead, when the tag icon 42 is touched, a new search using the tag contents as the search keywords may be performed. For example, when the user touches the tag icon 42 corresponding to “Toilet”, a new search for the facility using the search keyword “Toilet” is performed. Thus, it becomes possible to present the results of the search mainly using the tag information “Toilet”, in which the user interested.

### Modified Example 4

In the above embodiment, the tag information is information relevant to the equipment belonging to the facility. Instead, the tag information may be information relevant to events or services performed in the facility, for example.

### Modified Example 5

In the above example, the present invention is applied to the search for the facilities in the car navigation device. Instead, the present invention may be applied to a general Web search. For example, when a user watching a drama currently being broadcasted (Drama name: “◯◯”) makes a search with a search keyword “Actor” and the detail of the search results includes the drama “◯◯”, a tag “XX (the actor appearing in the drama ◯◯)” may be added to the search results.

### INDUSTRIAL APPLICABILITY

This invention can be used for a system displaying information on a terminal device.

### BRIEF DESCRIPTION OF REFERENCE NUMBERS

1 Information display system
10 Server
11 Search unit
12 Search DB
13 Tag recommending unit
14 User attribute DB
20 Terminal device
20a Smartphone
20b Car navigation device

1. An information display device comprising:
a receiving unit configured to receive a search condition from a user;
a search object obtaining unit configured to obtain search object information indicating a search object searched based on the search condition;
an additional information obtaining unit configured to obtain additional information with respect to the search object, based on the search condition, an attribute and/or a current situation of the user; and
a display unit configured to display an additional image indicating the additional information, together with the search object information.

2. The information display device according to claim 1,
wherein the search object information includes facility information relevant to a facility, and
wherein the display unit preferentially displays the facility information of a facility having the additional information, out of a plurality of facility information, in accordance with a designation by the user.

3. The information display device according to claim 1,
wherein the search object information includes facility information relevant to a facility,
wherein the additional information is information relevant to equipment existing in the facility, and
wherein the display unit displays detailed image information indicating a position of the equipment in the facility when the user selects the additional information.

4. The information display device according to claim 3,
wherein the search object obtaining unit obtains the facility information obtained by a new search based on the search condition including the equipment corresponding to the additional image when the user selects the additional information, and
wherein the display unit displays the facility information obtained by the new search.

5. The information display device according to claim 1, wherein the additional information obtaining unit obtains the additional information based on the attribute and/or the current situation of the user obtained, without receiving an input by the user.

6. An information display method executed by an information display device, comprising:
a receiving process configured to receive a search condition from a user;
a search condition obtaining process configured to obtain search object information indicating a search object searched based on the search condition;
an additional information obtaining process configured to obtain additional information with respect to the search object, based on the search condition, an attribute and/or a current situation of the user; and
a display process configured to display an additional image indicating the additional information, together with the search object information.

7. A non-transitory computer-readable medium storing a program executed by an information display device including a computer, the program causing the computer to function as:
a receiving unit configured to receive a search condition from a user;
a search object obtaining unit configured to obtain search object information indicating a search object searched based on the search condition;
an additional information obtaining unit configured to obtain additional information with respect to the search object, based on the search condition, an attribute and/or a current situation of the user; and
a display unit configured to display an additional image indicating the additional information, together with the search object information.

8. (canceled)

9. An information display system comprising:
a receiving unit configured to receive a search condition from a user;
a first obtaining unit configured to obtain an attribute and/or a current situation of the user;
a second obtaining unit configured to obtain search object information indicating a search object searched based on the search condition;
a third obtaining unit configured to obtain additional information with respect to the search object, based on the search condition, an attribute and/or a current situation of the user; and
a display unit configured to display an additional image indicating the additional information, together with the search object information.
